(19) United States
(12) Patent Application Publication
(10) Pub. No.: US 2025/0272608 A1
(43) Pub. Date: Aug. 28, 2025

(54) HYBRID ARTIFICIAL INTELLIGENCE CLASSIFIER

(71) Applicant: Camelot UK Bidco Limited, London (GB)

(72) Inventors: Saurabh MISHRA, Bhagalpur (IN); Ciaran COONEY, Barcelona (ES); Amirhossein YOUSEFIRAMANDI, Barcelona (ES); Akanksha MISHRA, Shivpuri (IN)

(21) Appl. No.: 18/590,188

(22) Filed: Feb. 28, 2024

(51) Int. Cl. G06N 20/00

(52) U.S. Cl. CPC G06N 20/00

(57) ABSTRACT

System, methods, apparatuses, and computer program products are disclosed for generating and using a hybrid artificial intelligence classifier for classifying input into one or more nodes of a taxonomy. Training data is received for at least a first portion of the taxonomy and used to train a supervised machine learning (ML) model to classify input into the first portion of the taxonomy having training data. A large language model (LLM) taxonomy is determined for at least a second portion of the taxonomy. The hybrid AI classifier classifies input based on a first classification obtained by providing the input to the supervised ML, and a second classification obtained by providing at least the input and the LLM taxonomy to a pre-trained LLM.

### BACKGROUND

Classification of information into a taxonomy involves organizing and categorizing data into one or more nodes of a data structure based on shared characteristics or attributes. This may include classifying information into a hierarchical data structure of categories and subcategories, with each level of the hierarchy representing a progressively more specific level of detail. Artificial intelligence (AI) classification systems may leverage machine learning to classify information into one or more categories of a taxonomy.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

System, methods, apparatuses, and computer program products are disclosed for generating and using a hybrid artificial intelligence classifier for classifying input into one or more nodes of a taxonomy. Training data is received for at least a first portion of the taxonomy and used to train a supervised machine learning (ML) model to classify input into the first portion of the taxonomy having training data. A large language model (LLM) taxonomy is determined for at least a second portion of the taxonomy. The hybrid AI classifier classifies input based on a first classification obtained by providing the input to the supervised ML, and a second classification obtained by providing at least the input and the LLM taxonomy to a pre-trained LLM.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for generating a hybrid artificial intelligence (AI) classifier and classifying input using the generated hybrid AI classifier, in accordance with an embodiment.

FIG. 2 depicts a block diagram of an example system for generating a hybrid AI classifier, in accordance with an embodiment.

FIG. 3 depicts a block diagram of an example system for classifying an input using a hybrid AI classifier, in accordance with an embodiment.

FIG. 4 depicts a flowchart of a process for generating a hybrid AI classifier, in accordance with an embodiment.

FIG. 5 depicts a flowchart of a process for classifying an input into a first layer of a taxonomy using a hybrid AI classifier, in accordance with an embodiment.

FIG. 6 depicts a flowchart of a process for classifying an input into a first layer of a taxonomy using a hybrid AI classifier, in accordance with an embodiment.

FIG. 7 depicts a flowchart of a process for classifying an input into a first layer of a taxonomy using a hybrid AI classifier, in accordance with an embodiment.

FIG. 8 depicts a flowchart of a process for classifying an input into multiple layers of a taxonomy using a hybrid AI classifier, in accordance with an embodiment.

FIG. 9 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

As used herein, the term “taxonomy” refers a classification system that organizes entities into hierarchical or non-hierarchical structures based on shared characteristics. In embodiments, a “hierarchical taxonomy” may include a tree-like taxonomy where entities are grouped based on shared characteristics and organized into nested levels of increasing specificity. In embodiments, a “non-hierarchical taxonomy” may include a flat taxonomy where entities are organized into categories without imposing strict hierarchical (e.g., ancestor-descendant) relationship on the categories.

### II. Example Embodiments

Artificial intelligence (AI) classifiers are models designed for the systematic categorization of data into hierarchical taxonomies. These classifiers utilize machine learning and pattern recognition algorithms to automatically assign elements to one or more nodes of a taxonomy having broader categories subdivided into more specific subcategories. By leveraging features and characteristics of the data, AI classifiers are able to discern relationships and make predictions about the appropriate categories of a taxonomy.

Generating an AI classifier can be a complicated process requiring substantial knowledge and human input. For instance, to generate an AI classifier using machine learning techniques, a subject matter expert may need to provide appropriate training data for each of the categories and/or subcategories of the taxonomy. In scenarios, the lack of high quality training data for some categories and/or subcategories of the taxonomy may impact the accuracy of the trained AI classifier.

Embodiments disclosed herein are directed to the generation and/or use of a hybrid artificial intelligence (AI) classifier that classifies data based on a classification generated by a trained machine learning (ML) model and a classification generated by a large language model (LLM). The hybrid AI classifier is capable of classifying data into one or more nodes of a taxonomy without training data for every category and/or subcategory of the taxonomy. In embodiments, the trained ML model is trained to classify data into a first subset of the taxonomy for which training data exists. For a second subset of the taxonomy with insufficient and/or no training data, the hybrid AI classifier leverages the LLM to classify the data into one or more nodes of a taxonomy. In embodiments, the hybrid AI classifier comprises an LLM taxonomy that includes a natural language description for categories and/or subcategories of the taxonomy. The hybrid AI classifier may leverage the LLM to classify data by providing the data and the LLM taxonomy to the LLM in a prompt requesting classification of the data into the LLM taxonomy.

In embodiments, the hybrid AI classifier classifies data into one or more nodes of a taxonomy by combining a first classification generated by the trained ML model and a second classification generated by the LLM. For instance, the hybrid AI classifier may provide the data to the trained ML model, and receive the first classification and a first confidence score indicative of the accuracy of the first classification. Similarly, the hybrid AI classifier may provide the data, along with the LLM taxonomy, to the LLM, and receive the second classification and a second confidence score indicative of the accuracy of the second classification. In embodiments, the hybrid AI classifier may classify the data based on the first classification, the first confidence score, the second classification, and the second confidence score. For instance, the hybrid AI classifier may classify the data in the first classification if the first confidence score is greater than the second confidence score, or classify the data in the second classification if the second confidence score is greater than the first confidence score.

In embodiments, the hybrid AI classifier may also provide the first classification and/or the first confidence score to the LLM. For instance, the hybrid AI classifier may provide a prompt to the LLM that includes the data to be classified, the LLM taxonomy, the first classification as a likely classification, and/or the first confidence score as an accuracy of the first classification. In embodiments, the second classification and/or the second confidence score returned by the LLM may account for the prediction made by the trained ML model. As such, the hybrid AI classifier may classify the data into the second classification that is returned by the LLM.

Generation of the hybrid AI classifier may begin with a user-provided or predetermined taxonomy, that may include, but is not limited to, a category of the taxonomy, a subcategory of the taxonomy, a relationship between a category and subcategory of the taxonomy, a label (e.g., name, heading, etc.) of a category or subcategory of the taxonomy, and/or a brief description of the taxonomy. In embodiments, the taxonomy may be provided by a client (e.g., user, subject matter expert, customer, script, etc.) through an interface (e.g., graphical user interface (GUI), application programming interface (API), etc.). In embodiments, the description or definition of the taxonomy may be semi-automatically developed by providing a predetermined taxonomy to the user, and interacting with the user to modify the predetermined taxonomy. In embodiments, the generated taxonomy may be represented as a set of nodes representative of categories and/or subcategories of the taxonomy, and a set of relationships representative of the relationship between an ancestor node and a descendent node in the taxonomy. In embodiments, nodes of the taxonomy may be associated with a description (e.g., name, summary, etc.) of the category and/or subcategory represented by the node, and/or training data associated with the category and/or subcategory.

Training data for the categories and/or subcategories of the taxonomy may, in embodiments, be provided by the client in various ways, such as, but not limited to, as textual data, as non-textual data, as a file, as an identifier (e.g., patent number, publication identifier, universal resource locator (URL), etc.), and/or the like. For instance, training data provided as patent numbers, publication identifiers, and/or URL may cause the retrieval of textual data (e.g., article, patent, etc.) associated therewith. In embodiments, training data provided as non-textual data (e.g., images, videos, audio, etc.) may be provided to a data processor (e.g., analyzer) to generate a textual description of the non-textual data. For instance, speech recognition may be employed to convert audio data into text, optical character recognition (OCR) may be employed to extract text from images and/or videos, image recognition may be employed to generate a textual description of the content of non-textual data, metadata (e.g., description, closed-caption text, etc.) may be extracted from the non-textual data.

An ML taxonomy may, in embodiments, be generated by extracting categories and/or subcategories from the taxonomy based on the availability of training data for the categories and/or subcategories. For instance, nodes of the taxonomy that have training data are included in the ML taxonomy. In embodiments, nodes of the taxonomy without training data may also be included in the ML taxonomy if training data is available for a subordinate (e.g., child) node. For instance, nodes of the taxonomy without training data may adopt the training data of subordinate nodes as its own training data.

The hybrid AI classifier may comprise one or more trained ML models for classifying data into a level of the taxonomy. For instance, a first trained ML model may be trained to determine a first level classification based on training data associated with the categories in a first level of the taxonomy. Subsequent to determining the first level classification for the data, the data may, in embodiments, be provided to a second trained ML model that is trained to determine a second level classification based training data associated with subcategories in a second level of the taxonomy that are subordinate to the determined first level classification. Classifications for subsequent layers in the taxonomy may be determined in a similar manner by providing the data to a subsequent trained ML model that is trained to determine a subcategory classification based on training data associated with subcategories in a level of the taxonomy that are subordinate to the classification determined at the preceding level of the taxonomy.

The trained ML models may, in embodiments, be trained using supervised machine learning techniques based on labeled training datasets. In embodiments, the labeled training dataset for training a first trained ML model to classify data into a first level of the taxonomy may comprise the training data associated with nodes in the first level of the ML taxonomy labeled with an identifier (e.g., category name, category description, category identifier, etc.) of the associated nodes. The labeled training dataset may, in embodiments, be divided into a first subset training dataset for training and a second subset validation dataset for validation. For instance, trained ML models may, in embodiments, be trained by iteratively adjusting the parameters of the model to minimize a loss function between its predicted classification and the actual classification in the first subset training dataset. The performance of the model is then evaluated on the second subset validation dataset to assess its ability to accurately classify new or unseen data. The trained ML models may be generated based on various ML algorithms, such as, but not limited to, support vector machines (SVM), logistic regression, decision trees, random forest, k-nearest neighbors (KNN), Naïve Bayes, gradient boosting, neural networks, and/or the like.

An LLM taxonomy may, in embodiments, be generated by determining textual descriptions for the categories and/or subcategories of the taxonomy. Textual descriptions for the categories and/or subcategories of the taxonomy may, in embodiments, be provided by the client in various ways, such as, but not limited to, as a natural language description of the categories and/or subcategories. In embodiments, a client may not provide a textual description for all categories and/or subcategories of the taxonomy. In such instances, a textual description of the categories and/or subcategories may be determined from data (e.g., training data, category name, etc.) associated therewith. In embodiments, textual descriptions for categories and/or subcategories may be determined by analyzing training data that may be available for the categories and/or subcategories. In embodiments, a textual description for nodes of the taxonomy without training data may be determined based on the textual description and/or training data that is available for a subordinate (e.g., child) node.

The hybrid AI classifier may employ an LLM to classify data into a level of the taxonomy. For instance, to classify data into a first level of a taxonomy, the hybrid AI classifier may provide, to the LLM, the data and nodes of a first layer of the LLM taxonomy corresponding to the first level of the taxonomy in a prompt requesting classification of the data into the first layer of the LLM taxonomy. In embodiments, a corresponding response from the LLM may include a first level classification of the data in the LLM taxonomy. Subsequently, the hybrid AI classifier may employ the LLM to classify the data into a second level of the taxonomy by providing, to the LLM, the data and nodes of a second layer of the LLM taxonomy that are subordinate to the first level classification in a prompt requesting classification of the data into includes the second layer of the LLM taxonomy.

In embodiments, the hybrid AI classifier classifies data into a first level of the taxonomy by combining first level classifications generated by a first trained ML model and the LLM. For instance, the hybrid AI classifier may provide the data to the first trained ML model, and receive a first classification in the first level of the taxonomy and a first confidence score indicative of the accuracy of the first classification. Similarly, the hybrid AI classifier may provide the data, along with the first level of the LLM taxonomy, to the LLM, and receive a second classification in the first level of the taxonomy and a second confidence score indicative of the accuracy of the second classification. In embodiments, the hybrid AI classifier may generate a first level classification for the data based on the first classification, the first confidence score, the second classification, and the second confidence score. For instance, the hybrid AI classifier may determine the first level classification for the data as the first classification if the first confidence score is greater than the second confidence score, or as the second classification if the second confidence score is greater than the first confidence score. In embodiments, the hybrid AI classifier may also provide the first classification in the first level of the taxonomy and/or the first confidence score to the LLM. For instance, the hybrid AI classifier may provide a prompt to the LLM that includes the data to be classified, the first level of the LLM taxonomy, the first classification in the first level of the taxonomy as a likely classification, and/or the first confidence score as an accuracy of the first classification. In embodiments, the second classification in the first level of the taxonomy and/or the second confidence score returned by the LLM may account for the prediction made by the trained ML model. As such, the hybrid AI classifier may determine the first level classification of the data as the second classification that is returned by the LLM.

In embodiments, the hybrid AI classifier classifies data into a subsequent level of the taxonomy by combining subsequent level classifications generated by a second trained ML model and the LLM. For instance, the hybrid AI classifier may provide the data to the second trained ML model, and receive a third classification in the subsequent level of the taxonomy and a third confidence score indicative of the accuracy of the third classification. Similarly, the hybrid AI classifier may provide the data, along with the subsequent level of the LLM taxonomy that is subordinate to a previous level classification, to the LLM, and receive a fourth classification in the subsequent level of the taxonomy and a fourth confidence score indicative of the accuracy of the fourth classification. In embodiments, the hybrid AI classifier may generate a subsequent level classification for the data based on the third classification, the third confidence score, the fourth classification, and the fourth confidence score. For instance, the hybrid AI classifier may determine the subsequent level classification for the data as the third classification if the third confidence score is greater than the fourth confidence score, or as the fourth classification if the fourth confidence score is greater than the third confidence score. In embodiments, the hybrid AI classifier may also provide the third classification in the subsequent level of the taxonomy and/or the third confidence score to the LLM. For instance, the hybrid AI classifier may provide a prompt to the LLM that includes the data to be classified, the subsequent level of the LLM taxonomy that is subordinate to the previous level classification, the third classification in the subsequent level of the taxonomy as a likely classification, and/or the third confidence score as an accuracy of the third classification. In embodiments, the fourth classification in the subsequent level of the taxonomy and/or the fourth confidence score returned by the LLM may account for the prediction in the subsequent level of the taxonomy made by the second trained ML model. As such, the hybrid AI classifier may determine the subsequent level classification of the data as the fourth classification that is returned by the LLM. The hybrid AI classifier may, in embodiments, repeat this process for additional levels of the taxonomy until a termination condition is satisfied, including, but not limited to, until there are no additional levels of the taxonomy, until the accuracy of the classification fails to satisfy a predetermined accuracy threshold, until the number of levels classified by the hybrid AI classifier exceeds a classification depth threshold, and/or the like.

These and further embodiments are disclosed herein that enable the functionality described above and additional functionality. Such embodiments are described in further detail as follows.

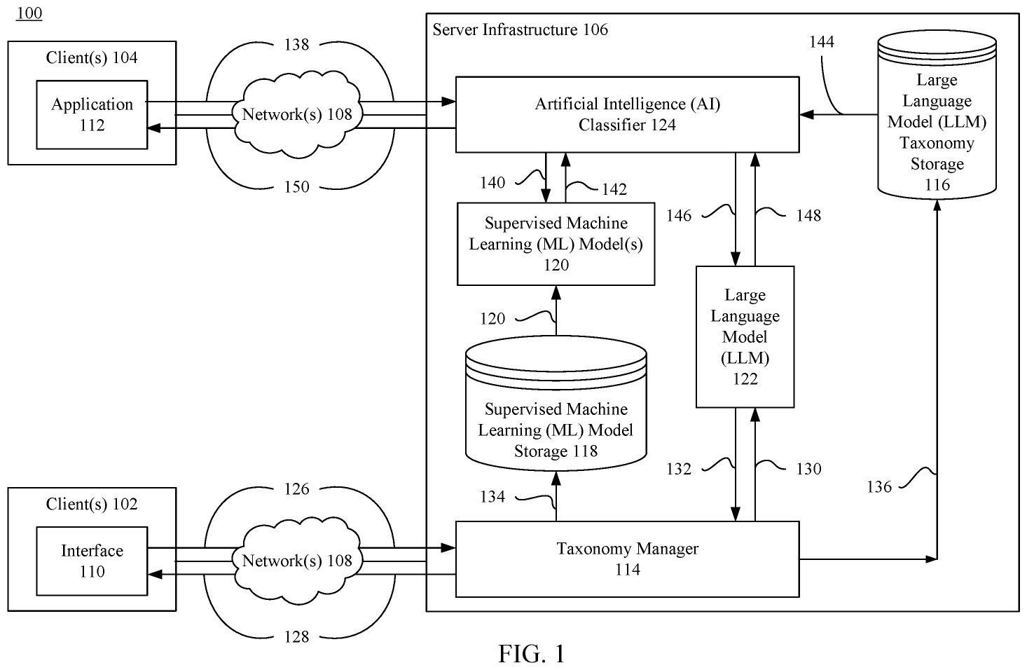

For instance, FIG. 1 depicts a block diagram of an example system 100 for generating a hybrid artificial intelligence (AI) classifier and classifying input using the generated hybrid AI classifier, in accordance with an embodiment. As shown in FIG. 1, system 100 includes one or more clients 102 and one or more clients 104 communicatively coupled to a server infrastructure 106 via one or more networks 108. Furthermore, client(s) 102 may include an interface 110, and client(s) 104 may include an application 112. Additionally, server infrastructure 106 may include a taxonomy manager 114, LLM taxonomy storage 116, a supervised ML model storage 118, one or more supervised ML models 120, an LLM 122, and an AI classifier 124. System 100 is described in further detail as follows.

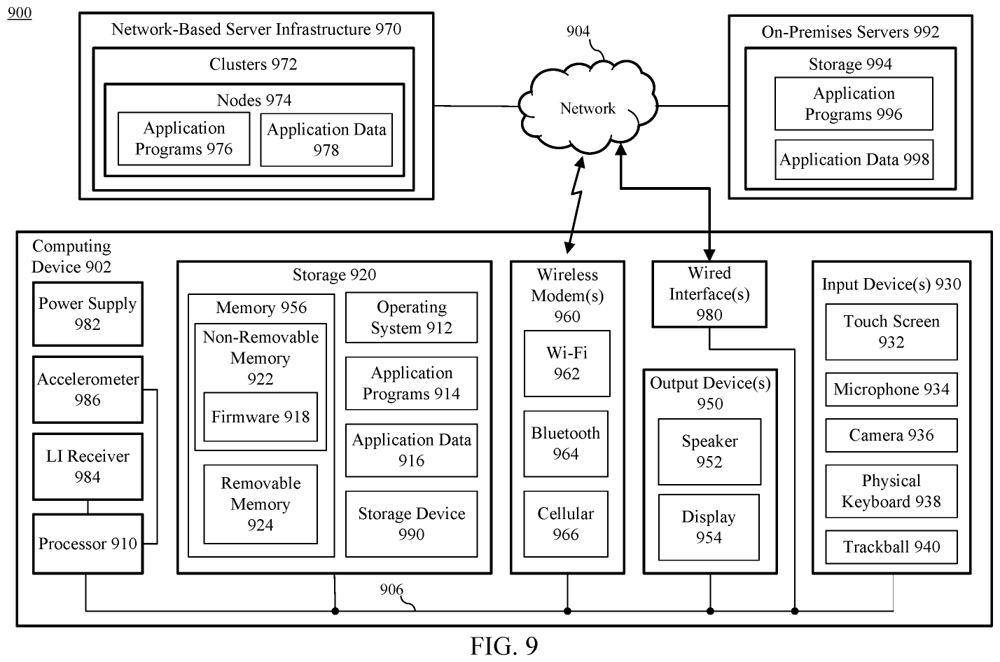

Client(s) 102 and/or 104 comprise any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. As shown in FIG. 1, client(s) 102 include interface 110, and client(s) 104 include application 112. Various example implementations of client(s) 102 and/or 104 are described below in reference to FIG. 9 (e.g., computing device 902, network-based server infrastructure 970, on-premises servers 992, and/or components thereof).

Interface 110 may comprise an interface that enables a user and/or program of client(s) 102 to interact with taxonomy manager 114 to generate supervised ML model(s) 120, and/or LLM taxonomy 136 to enable AI classifier 124 to classify data into the taxonomy. In embodiments, interface 110 includes, but is not limited to, a graphical user interface (GUI), a voice interface, a chatbot interface, a chat interface, a digital assistant, a command line interface (CLI), an application programming interface (API), and/or the like. In embodiments, interface 110 may accept various inputs, such as, but not limited to, natural language descriptions of the taxonomy and/or categories and/or subcategories thereof, training data (e.g., textual data, non-textual data, URLs, patent numbers, publication identifiers, etc.). In embodiments, interface 110 may interact with taxonomy manager 114 using one or more interface requests 126 and/or one or more interface responses 128.

Application 112 may comprise various applications, such as, but not limited to, mobile applications, desktop applications, a web browser, server applications, scripts, and/or the like. In embodiments, application 112 provides, to AI classifier 124, a classification request 138 requesting a classification of data. Various example implementations of application 112 are described below in reference to FIG. 9 (e.g., application programs 914, application programs 976, application programs 996, and/or components thereof).

Network(s) 108 comprise one or more networks such as local area networks (LANs), wide area networks (WANs), enterprise networks, the Internet, etc., and may include one or more wired and/or wireless portions. In embodiments, network(s) 108 connecting client(s) 102 to server infrastructure 106 may be the same as, may overlap with, and/or may be mutually exclusive of network(s) 108 connecting client(s) 104 to server infrastructure 106. Various example implementations of network(s) 108 are described below in reference to FIG. 9 (e.g., network 904, and/or components thereof).

Server infrastructure 106 may comprise a network-accessible server set (e.g., cloud-based environment or platform). In an embodiment, the underlying resources of server infrastructure 106 are co-located (e.g., housed in one or more nearby buildings with associated components such as backup power supplies, redundant data communications, environmental controls, etc.) to form a datacenter, are distributed across different regions, and/or are arranged in other manners. As shown in FIG. 1, server infrastructure 106 further includes taxonomy manager 114, LLM taxonomy storage 116, supervised ML model(s) 120, LLM 122, AI classifier 124. Various example implementations of server infrastructure 106 are described below in reference to FIG. 9 (e.g., network-based server infrastructure 970, and/or components thereof).

Taxonomy manager 114 is configured to generate a taxonomy based on interactions with interface 110 of client(s) 102. For instance, taxonomy manager 114 may receive, via request(s) 126, one or more of: a request to create a hybrid AI classifier for classifying information into one or more nodes of a user-provided or predetermined taxonomy, training data for one or more categories and/or subcategories of the taxonomy, natural language descriptions for one or more categories and/or subcategories of the taxonomy, and/or the like. In embodiments, taxonomy manager 114 may provide an interface to enable a user of client(s) 102 to provide the structure (e.g., levels, nodes, leaves, etc.), categories (e.g., category name, category identifier, category description, etc.), and/or subcategories of the taxonomy (e.g., subcategory name, subcategory identifier, subcategory description, etc.). In embodiments, a user of client(s) 102 may generate a new taxonomy by providing a natural language description 130 of the taxonomy to LLM 122 via taxonomy manager 114. An initial taxonomy 132 generated by LLM 122 may be provide by taxonomy manager 114 to client(s) 102 as a starting point for defining the new taxonomy. For instance, initial taxonomy 132 may be presented in interface 110 to enable a user of client(s) 102 to modify or customize initial taxonomy 132 to suit the needs of the user. In embodiments, taxonomy manager 114 may also provide an interface to client(s) 102 to provide training data and/or natural language definitions for categories and/or subcategories of the taxonomy. In embodiments, taxonomy manager 114 may also provide an interface to client(s) 102 to provide training data and/or natural language definitions for categories and/or subcategories of the taxonomy.

In embodiments taxonomy manager 114 may be further configured to generate elements that enable AI classifier 124 to perform hybrid AI classification responsive to a classification request 138. For instance, taxonomy manager 114 may generate one or more LLM taxonomies 136, store LLM taxonomy(s) 136 in LLM taxonomy storage 116.

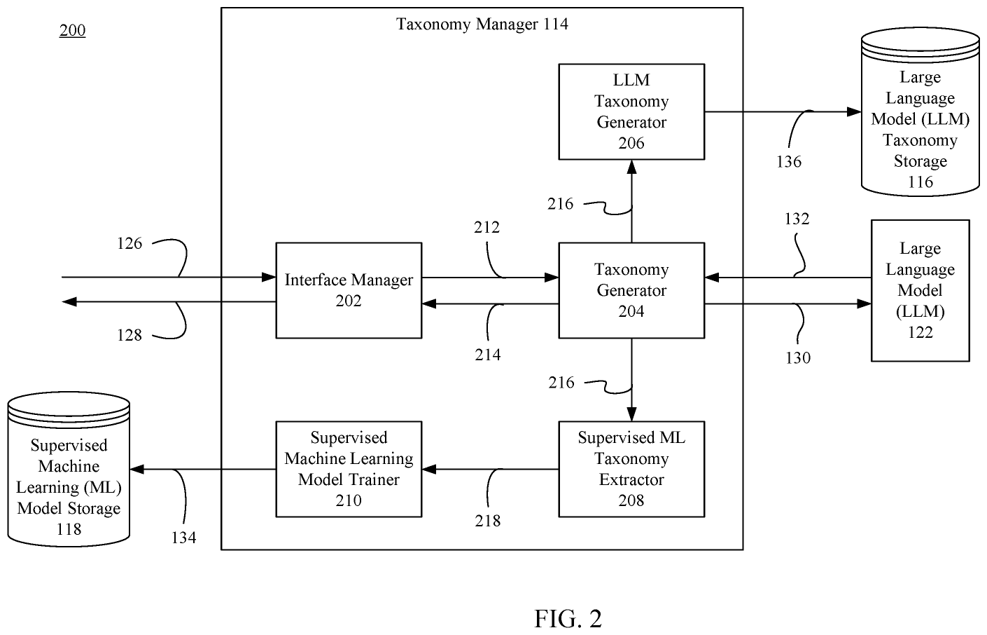

Furthermore, taxonomy manager 114 may train one or more ML models 134 based on training data received from client(s) 102 via interface 110, and store trained ML model(s) 134 in supervised ML model storage 118 for future use by AI classifier 124. Taxonomy manager 114 will be discussed in greater detail below in conjunction with FIG. 2.

LLM taxonomy storage 116 is configured to store LLM taxonomy(s) 136 generated by taxonomy manager 114 for future use by AI classifier 124 to classify data into one or more levels of the LLM taxonomy. In embodiments, LLM taxonomy storage 116 may store LLM taxonomy(s) 136 in various data structures, such as, but not limited to, trees, graphs, lists, dictionaries, and/or the like.

Supervised ML model storage 118 is configured to receive and store trained ML model(s) 134 for future use by AI classifier 124. In embodiments, trained ML model(s) 134 stored in supervised ML model storage 118 may be retrieved and/or loaded from supervised ML model storage 118 as supervised ML model(s) 120 when needed for processing classification request 138.

Supervised ML model(s) 120 are configured to classify an input into one or more levels of the taxonomy. For instance, supervised ML model(s) 120 may classify an input 140 into a first level of the taxonomy by determining one or more categories in the first level of the taxonomy most appropriate to the input. In embodiments, supervised ML model(s) 120 may provide an ML-generated classification 142 that may include the determined category(s) and/or a confidence score associated with the determined category(s). In embodiments, supervised ML model(s) 120 relevant to processing classification request 138 may be retrieved and/or loaded from supervised ML model storage 118 when needed.

LLM 122 may include a generic pre-trained language model trained on vast amounts of diverse data, and be enabled to perform a wide range of natural language processing tasks. In embodiments, LLM 122 is enabled to receive a prompt comprising a request to classify an input into a LLM taxonomy, the input, and/or at least a portion of the LLM taxonomy, and return an LLM-generated classification 148 for the input. In embodiments, LLM 122 may include a multimodal LLM (MLLM) that is capable of accepting input in a plurality of modalities, and generating a response in a plurality of modalities.

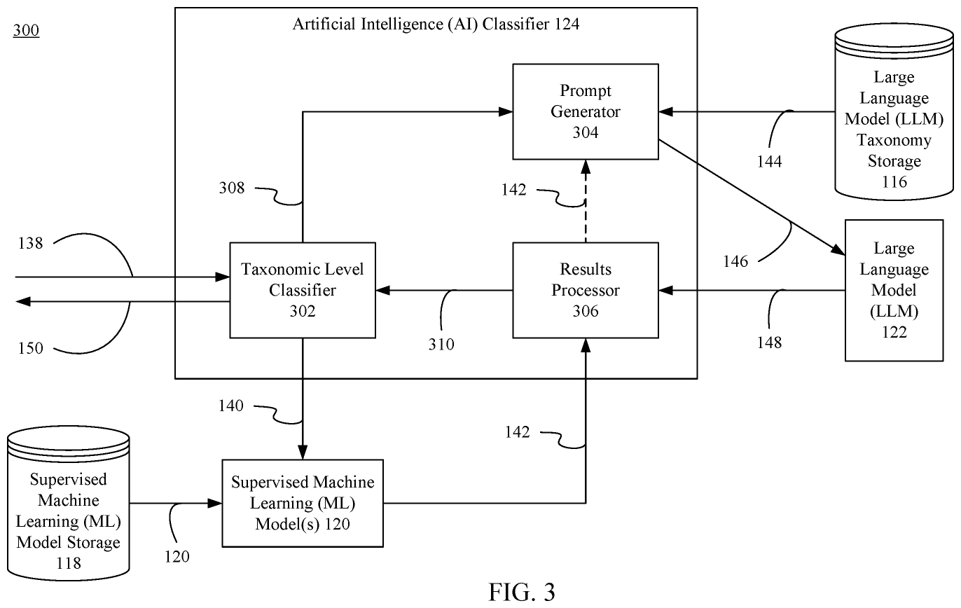

AI classifier 124 is configured to receive a classification request 138 that includes input data to be classified, and to classify the input data by combining ML-generated classification 142 generated by supervised ML model(s) 120 and LLM-generated classification 148 generated by LLM 122. In embodiments, AI classifier 124 may classify the input data in phases by determining a first level classification of the input data in a first level of the taxonomy in a first phase, and then determining a second level classification of the input data in a second level of the taxonomy that is subordinate to the first level of the taxonomy. In embodiments, determining a second level classification of the input data in a second level of the taxonomy may be limited to subcategories in the second level of the taxonomy that are subordinate to the determined first level classification of the input data. AI classifier 124 will be described in greater detail below in conjunction with FIG. 3.

Embodiments described herein may operate in various ways to generate a hybrid AI classifier. For example, FIG. 2 depicts a block diagram of an example system 200 for generating a hybrid AI classifier, in accordance with an embodiment. As shown in FIG. 2, system 200 includes taxonomy manager 114, LLM taxonomy storage 116, and supervised ML model storage 118. In system 200, taxonomy manager 114 further includes an interface manager 202, a taxonomy generator 204, an LLM taxonomy generator 206, a supervised ML taxonomy extractor 208, and a supervised ML model trainer 210. System 200 is described in further detail as follows.

Interface manager 202 is configured to interact with interface 110 of client(s) 102 through request(s) 126 and/or response(s) 128 to generate a new taxonomy. For instance, interface manager 202 may receive, via request(s) 126, one or more of: a request to create a hybrid AI classifier for classifying information into one or more nodes of a user-provided or predetermined taxonomy, training data for one or more categories and/or subcategories of the taxonomy, natural language descriptions for one or more categories and/or subcategories of the taxonomy, and/or the like. In embodiments, interface manager 202 may provide an interface to enable a user of client(s) 102 to provide the structure (e.g., levels, nodes, leaves, etc.), categories (e.g., category name, category identifier, category description, etc.), and/or subcategories of the taxonomy (e.g., subcategory name, subcategory identifier, subcategory description, etc.). For instance, client(s) 102 may provide training data for the categories and/or subcategories of the taxonomy to interface manager 202 in various ways, such as, but not limited to, as textual data, as non-textual data, as a file, as an identifier (e.g., patent number, publication identifier, universal resource locator (URL), etc.), and/or the like. For instance, training data provided as patent numbers, publication identifiers, and/or URL may cause interface manager 202 to retrieve textual data (e.g., article, patent, etc.) associated therewith. In embodiments, interface manager 202 may process training data provided as non-textual data (e.g., images, videos, audio, etc.) to generate a textual description of the non-textual data. In embodiments, interface manager 202 provides data 212 to taxonomy generator 204 to enable taxonomy generator 204 to generate a taxonomy.

Taxonomy generator 204 is configured to generate a new taxonomy based on taxonomy data 212 determined by interface manager 202 through interactions with client(s) 102. In embodiments, taxonomy generator 204 may provide, to LLM 122, a natural language description 130 of the taxonomy, and receive, from LLM 122, an initial taxonomy 132. Taxonomy generator 204 may provide initial taxonomy 132 as taxonomy updates 214 to interface manager 202 for transfer to client(s) 102 as a starting point for defining the new taxonomy. For instance, initial taxonomy 132 may be presented in interface 110 to enable a user of client(s) 102 to modify or customize initial taxonomy 132 to suit the needs of the user. In embodiments, taxonomy generator 204 may receive, for categories and/or subcategories of the taxonomy, client-provided training data and/or natural language definitions. In embodiments, taxonomy generator 205 may organize taxonomy data 212 into a taxonomy data structure 216 by organizing the categories and/or subcategories into a plurality of nodes, connecting categories and subcategories with edges representative of ancestor-descendant relationships, associating natural language definitions of categories and/or subcategories with nodes corresponding to the categories and/or subcategories, and/or associated available training data for categories and/or subcategories with nodes corresponding to the categories and/or subcategories. In embodiments, taxonomy data structure 216 may comprise a plurality of data structures associated with types of taxonomy data. In embodiments, taxonomy generator 204 may provide taxonomy data structure 216 to supervised ML taxonomy extractor 208 and/or LLM taxonomy generator 206.

LLM taxonomy generator 206 is configured to receive taxonomy data structure 216 from taxonomy generator 204, and generate LLM taxonomy 136. In embodiments, LLM taxonomy generator 206 may analyze taxonomy data structure 216 to determine categories and/or subcategories that lack a natural language definition, and generate a natural language definition for the categories and/or subcategories that lack a natural language definition. For instance, LLM taxonomy generator 206 may generate a natural language definition for a category that lacks a natural language definition based on one or more of: a label (e.g., name, identifier) associated with the category and/or subcategories subordinate to the category, natural language definitions of subcategories subordinate to the category, and/or training data associated with the category and/or subcategories subordinate to the category. In embodiments, LLM taxonomy generator 206 may generate LLM taxonomy 136 by combining client-provided natural language definitions of categories and/or subcategories with natural language definitions generated by LLM taxonomy generator 206. LLM taxonomy generator 206 may store LLM taxonomy 136 in LLM taxonomy storage 116 for future use by AI classifier 124.

Supervised ML taxonomy extractor 208 is configured to receive taxonomy data structure 216 from taxonomy generator 204, and extracting an ML taxonomy 218 based on taxonomy data structure 216. In embodiments, supervised ML taxonomy extractor 208 may analyze taxonomy data structure 216 to determine categories and/or subcategories are associated with training data, and including in ML taxonomy 218 nodes associated with the categories and/or subcategories that are associated with training data and/or ancestor nodes of those nodes. For instance, ancestor nodes that are not directly associated with training data may indirectly adopt the training data associated with subordinate or child nodes. In embodiments, supervised ML taxonomy extractor 208 may exclude, from ML taxonomy 218, nodes in taxonomy data structure 216 that are not directly or indirectly associated with any training data. In embodiments, supervised ML taxonomy extractor 208 may provide ML taxonomy 218 as a labeled training dataset to supervised ML trainer 210.

Supervised ML model trainer 210 is configured to generate trained ML model(s) 134 using supervised machine learning techniques based on ML taxonomy 218. In embodiments, supervised ML model trainer 210 may divide the labeled training dataset according to the levels of the taxonomy. For instance, a labeled training dataset for training a first trained ML model to classify data into a first level of the taxonomy may comprise the training data associated with nodes in the first level of ML taxonomy 218 labeled with an identifier (e.g., category name, category description, category identifier, etc.) of the associated nodes. In embodiments, supervised ML model trainer 210 may divide the labeled training dataset into a first subset training dataset for training and a second subset validation dataset for validation. For instance, supervised ML model trainer 210 may train an ML model by iteratively adjusting the parameters of the model to minimize a loss function between its predicted classification and the actual classification in the training dataset. Supervised ML model trainer 210 may then validate the performance of the model by evaluating the model on the second subset validation dataset to assess its ability to accurately classify new or unseen data. In embodiments, supervised ML model trainer 210 may perform supervised training based on various ML algorithms, such as, but not limited to, support vector machines (SVM), logistic regression, decision trees, random forest, k-nearest neighbors (KNN), Naïve Bayes, gradient boosting, neural networks, and/or the like. Supervised ML model trainer 210 may train the models until a training termination condition is satisfied, including, but not limited to, until there are no additional levels of the taxonomy, until the accuracy of the classification fails to satisfy a predetermined accuracy threshold, until the number of levels classified by the hybrid AI classifier exceeds a classification depth threshold, and/or the like. In embodiments, supervised ML model trainer 210 may store trained ML model(s) 134 in supervised ML model storage 118 for future use by AI classifier 124.

Embodiments described herein may operate in various ways to classify an input using a hybrid AI classifier. For example, FIG. 3 depicts a block diagram of an example system 300 for classifying an input using a hybrid AI classifier, in accordance with an embodiment. As shown in FIG. 3, system 300 includes LLM taxonomy storage 116, supervised ML model storage 118, supervised ML model(s) 120, LLM 122, and AI classifier 124. In system 300, AI classifier 124 further includes a taxonomic level classifier 302, a prompt generator 304, and a results processor 306. System 300 is described in further detail as follows.

Taxonomic level classifier 302 is configured to receive classification request 138 to classify input 140 into the taxonomy, and iteratively classify input 140 into one or more levels of the taxonomy. In embodiments, taxonomic level classifier 302 may classify input 140 into a first level of the taxonomy based on a first classification of input 140 generated by a first supervised ML model 120 and a second classification of input 140 generated by LLM 122. For instance, taxonomic level classifier 302 may load a first supervised ML model 120 from supervised ML model storage 118, and provide input 140 to the first supervised ML model 120 trained to classify data into a first level of the taxonomy and to prompt generator 304 as prompt data 308. Taxonomic level classifier 302 may receive, from results processor 306, a level classification 310 of input 140 in the first level of the taxonomy.

In embodiments, taxonomic level classifier 302 may classify input 140 into a second level of the taxonomy based on a third classification of input 140 generated by a second supervised ML model 120 trained to classify data into a second level of the taxonomy and a fourth classification of input 140 generated by LLM 122. For instance, taxonomic level classifier 302 may load a second supervised ML model 120 from supervised ML model storage 118, and provide input 140 to the second supervised ML model 120 for classification into a second level of the taxonomy. In embodiments, taxonomic level classifier 302 may provide to prompt generator 304, as prompt data 308, input 140 and level classification 310 of input 140 in the first level of the taxonomy for classification into the second level of the taxonomy. Taxonomic level classifier 302 may receive, from results processor 306, a level classification 310 of input 140 in the second level of the taxonomy.

In embodiments, taxonomic level classifier 302 may classify input 140 into additional levels of the taxonomy in a similar manner until a classification termination condition is satisfied, for example, but not limited to, until the latest level classification of input 140 in the taxonomy does not contain any subordinate subcategories, until a classification detail threshold is satisfied, until an accuracy or confidence score associated with the latest level classification fails to satisfy an accuracy or confidence threshold, and/or the like. Upon satisfaction of the termination condition, taxonomic level classifier 302 may provide an overall classification of input 140 that comprises one or more level classifications 310 corresponding to one or more levels of the taxonomy.

Prompt generator 304 is configured to generate a prompt 146 requesting classification of input 140 in a level of the taxonomy. In embodiments, prompt generator 304 receives, from taxonomic level classifier 302, input 140, a level of the taxonomy, and/or level classification 310 as part of prompt data 308. Prompt generator 304 may retrieve, from LLM taxonomy storage 116, at least a portion of the LLM taxonomy 144 based on the level of the taxonomy. In embodiments, prompt generator 304 may receive ML-generated classification 142 from supervised ML model(s) 120 via results processor 306. In embodiments, prompt generator 304 may include, in prompt 146, a high-level instruction for LLM 122 requesting classification of input 140 into the portion of LLM taxonomy 144, input 140, the portion of LLM taxonomy 144, ML-generated classification 142 as a likely classification of input 140, and/or a confidence score associated with ML-generated classification 142.

Results processor 306 is configured to receive ML-generated classification 142 from supervised ML model(s) 120 and LLM-generated classification 148 from LLM 122, and determine level classification 310 of input 140 in a level of the taxonomy based on ML-generated classification 142 and LLM-generated classification 148. In embodiments, results processor 306 may also receive a first confidence score associated with ML-generated classification 142 supervised ML model(s) 120 and a second confidence score associated with LLM-generated classification 148 from LLM 122. In embodiments, results processor 306 may output ML-generated classification 142 as level classification 310 if the first confidence score is greater than the second confidence score, or output LLM-generated classification 148 as level classification 310 if the second confidence score is greater than the first confidence score.

In embodiments, results processor 306 may also provide ML-generated classification 142 and/or the first confidence score to prompt generator 304 for inclusion in prompt 146 as a likely classification of input 140. In embodiments, results processor 306 may output LLM-generated classification 148 as level classification 310 because LLM 122 accounted for ML-generated classification 142 when generating LLM-generated classification 148. In embodiments, results processor 306 may include ML-generated classification only when the first confidence score satisfies a predetermined relationship with a predetermined confidence threshold.

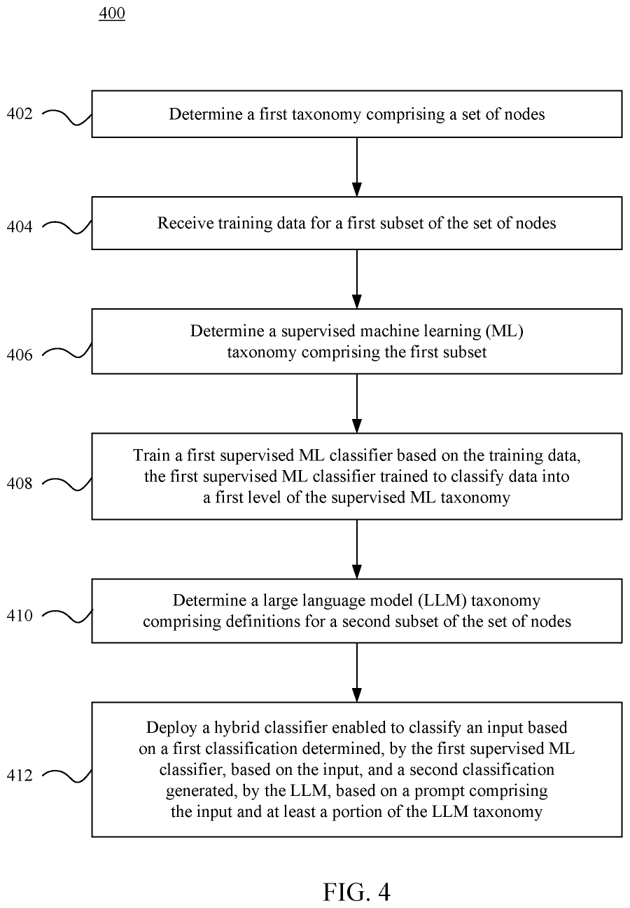

Embodiments described herein may operate in various ways to generate a hybrid AI classifier. FIG. 4 depicts a flowchart 400 of a process for generating a hybrid AI classifier, in accordance with an embodiment. Server infrastructure 106, taxonomy manager 114, LLM taxonomy storage 116, supervised ML model(s) 120, LLM 122, interface manager 202, taxonomy generator 204, LLM taxonomy generator 206, supervised ML taxonomy extractor 208, and supervised ML model trainer 210 of FIGS. 1-2 may operate in accordance with flowchart 400. Note that not all steps of flowchart 400 may need to be performed in all embodiments, and in some embodiments, the steps of flowchart 400 may be performed in different orders than shown. Flowchart 400 is described as follows with respect to FIGS. 1-2 for illustrative purposes.

Flowchart 400 starts at step 402. In step 402, a first taxonomy comprising a set of nodes is determined. For example, taxonomy generator 204 may generate taxonomy data structure 216 that comprises a set of nodes. In embodiments, taxonomy generator 204 provides taxonomy data structure 216 to LLM taxonomy generator 206 and/or supervised ML taxonomy extractor 208.

In step 404, training data is received for a first subset of the set of nodes. For example, interface manager 202 may receive training data from client(s) 102 and provide the training data to taxonomy generator 204 as data 212 for inclusion in taxonomy data structure 216. In embodiments, the training data may be provided to taxonomy data structure 216 to LLM taxonomy generator 206 and/or supervised ML taxonomy extractor 208 as part of taxonomy data structure 216.

In step 406, a supervised ML taxonomy is determined, the supervised ML taxonomy comprising the first subset. For example, supervised ML taxonomy extractor 208 may extract ML taxonomy 218 from taxonomy data structure 216 based on the availability of training data. For instance, supervised ML taxonomy extractor 208 may analyze taxonomy data structure 216 to determine categories and/or subcategories are associated with training data, and including in ML taxonomy 218 nodes associated with the categories and/or subcategories that are associated with training data and/or ancestor nodes of those nodes. For instance, ancestor nodes that are not directly associated with training data may indirectly adopt the training data associated with subordinate or child nodes. In embodiments, supervised ML taxonomy extractor 208 may exclude, from ML taxonomy 218, nodes in taxonomy data structure 216 that are not directly or indirectly associated with any training data. In embodiments, supervised ML taxonomy extractor 208 may provide ML taxonomy 218 as a labeled training dataset to supervised ML trainer 210.

In step 408, a first supervised ML classifier is trained based on the training data to classify data into a first level of the supervised ML taxonomy. For example, supervised ML trainer 210 may generate a first trained ML model 134 based on ML taxonomy 218. In embodiments, supervised ML model trainer 210 may perform supervised training based on various ML algorithms, such as, but not limited to, support vector machines (SVM), logistic regression, decision trees, random forest, k-nearest neighbors (KNN), Naïve Bayes, gradient boosting, neural networks, and/or the like. In embodiments, supervised ML model trainer 210 may store trained ML model(s) 134 in supervised ML model storage 118 for future use by AI classifier 124.

In step 410, an LLM taxonomy is determined, the LLM taxonomy comprising definitions for a second subset of the set of nodes. For example, LLM taxonomy generator may generate LLM taxonomy 136 by analyzing taxonomy data structure 216 to determine categories and/or subcategories that lack a natural language definition, and generating a natural language definition for the categories and/or subcategories that lack a natural language definition. For instance, LLM taxonomy generator 206 may generate a natural language definition for a category that lacks a natural language definition based on one or more of: a label (e.g., name, identifier) associated with the category and/or subcategories subordinate to the category, natural language definitions of subcategories subordinate to the category, and/or training data associated with the category and/or subcategories subordinate to the category. In embodiments, LLM taxonomy generator 206 may generate LLM taxonomy(s) 136 by combining client-provided natural language definitions of categories and/or subcategories with natural language definitions generated by LLM taxonomy generator 206.

In step 412, a hybrid classifier is deployed to enable classification of an input based on a first classification determined, by the first supervised ML classifier, based on the input, and a second classification determined by, the LLM, based on a prompt comprising the input and at least a portion of the LLM taxonomy. For example, supervised ML model trainer 210 may store trained ML model(s) 134 in supervised ML model storage 118 for future use by AI classifier 124, and LLM taxonomy generator 206 may store LLM taxonomy(s) 136 in LLM taxonomy storage 116 for future use by AI classifier 124. In embodiments, supervised ML model trainer 210 may deploy a hybrid classifier by instantiating one or more instances of supervised ML model(s) 120 to infrastructure 106.

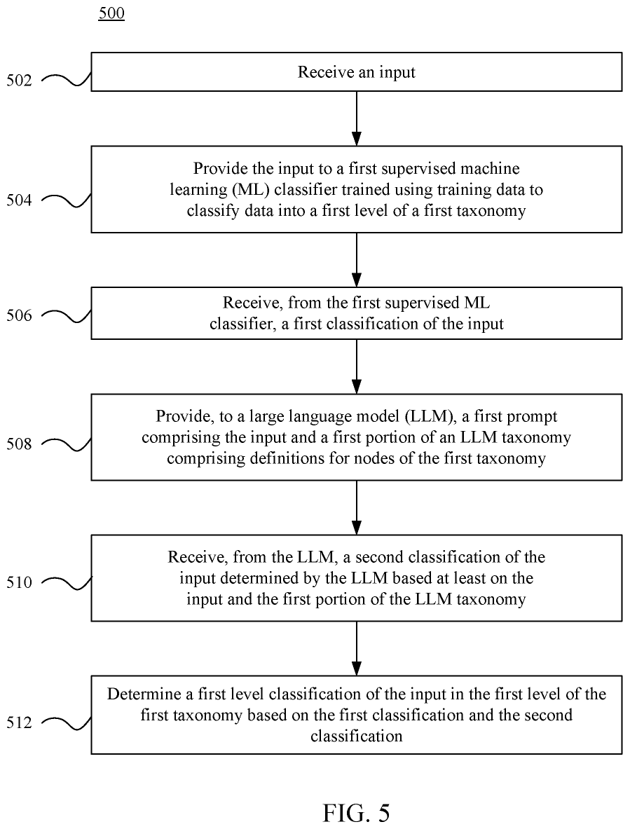

Embodiments described herein may operate in various ways to classify an input into a first layer of a taxonomy using a hybrid AI classifier. FIG. 5 depicts a flowchart 500 of a process for classifying an input into a first layer of a taxonomy using a hybrid AI classifier, in accordance with an embodiment. Server infrastructure 106, LLM taxonomy storage 116, supervised ML model(s) 120, LLM 122, AI classifier 124, taxonomic level classifier 302, prompt generator 304, results processor 306 of FIGS. 1 and 3 may operate in accordance with flowchart 500. Note that not all steps of flowchart 500 may need to be performed in all embodiments, and in some embodiments, the steps of flowchart 500 may be performed in different orders than shown. Flowchart 500 is described as follows with respect to FIGS. 1 and 3 for illustrative purposes.

Flowchart 500 starts at step 502. In step 502, an input is received. For example, taxonomic level classifier 302 may receive input 140 from client(s) 104 as part of classification request 138.

In step 504, the input is provided to a first supervised ML classifier trained using training data to classify data into a first level of a first taxonomy. For example, taxonomic level classifier 302 may provide input 140 to a first supervised ML model 120 trained to classify data into a first level of the taxonomy.

In step 506, a first classification of the input is received from the first supervised ML classifier. For example, results processor 306 may receive, from supervised ML model(s) 120, ML-generated classification 142 that may include a first classification and/or a confidence score associated with the first classification.

In step 508, a first prompt is provided to an LLM, the first prompt comprising the input and a first portion of the LLM taxonomy comprising definitions for nodes of the first taxonomy. For example, prompt generator 304 may provide, to LLM 122, prompt 146 that may include a high-level instruction for LLM 122 requesting classification of input 140 into the portion of LLM taxonomy 144, input 140, and/or the portion of LLM taxonomy 144.

In step 510, a second classification of the input is received from the LLM, the second classification determined by the LLM based at least on the input and first portion of the LLM taxonomy. For example, results processor 306 may receive, from LLM 122, LLM-generated classification 148 generated by LLM 122 based on input 140 and the portion of LLM taxonomy 144.

In step 512, a first level classification of the input in the first level of the first taxonomy is determined based on the first classification and the second classification. For example, results processor 306 may determine level classification 310 of input 140 in a first level of the taxonomy based on ML-generated classification 142 and LLM-generated classification 148.

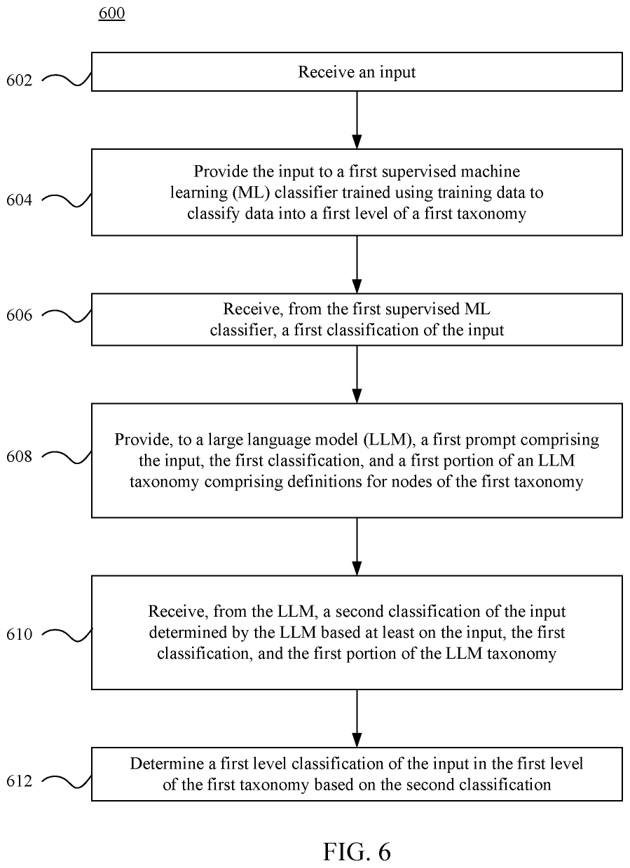

Embodiments described herein may operate in various ways to classify an input into a first layer of a taxonomy using a hybrid AI classifier. FIG. 6 depicts a flowchart 600 of a process for classifying an input into a first layer of a taxonomy using a hybrid AI classifier, in accordance with an embodiment. Server infrastructure 106, LLM taxonomy storage 116, supervised ML model(s) 120, LLM 122, AI classifier 124, taxonomic level classifier 302, prompt generator 304, results processor 306 of FIGS. 1 and 3 may operate in accordance with flowchart 600. Note that not all steps of flowchart 600 may need to be performed in all embodiments, and in some embodiments, the steps of flowchart 600 may be performed in different orders than shown. Flowchart 600 is described as follows with respect to FIGS. 1 and 3 for illustrative purposes.

Flowchart 600 starts at step 602. In step 602, an input is received. For example, taxonomic level classifier 302 may receive input 140 from client(s) 104 as part of classification request 138.

In step 604, the input is provided to a first supervised ML classifier trained using training data to classify data into a first level of a first taxonomy. For example, taxonomic level classifier 302 may provide input 140 to a first supervised ML model 120 trained to classify data into a first level of the taxonomy.

In step 606, a first classification of the input is received from the first supervised ML classifier. For example, results processor 306 may receive, from supervised ML model(s) 120, ML-generated classification 142 that may include a first classification and/or a confidence score associated with the first classification.

In step 608, a first prompt is provided to an LLM, the first prompt comprising the input, the first classification, and a first portion of the LLM taxonomy comprising definitions for nodes of the first taxonomy. For example, prompt generator 304 may provide, to LLM 122, prompt 146 that may include a high-level instruction for LLM 122 requesting classification of input 140 into the portion of LLM taxonomy 144, input 140, and/or the portion of LLM taxonomy 144.

In step 610, a second classification of the input is received from the LLM, the second classification determined by the LLM based at least on the input, the first classification, and first portion of the LLM taxonomy. For example, results processor 306 may receive, from LLM 122, LLM-generated classification 148 generated by LLM 122 based on input 140 and the portion of LLM taxonomy 144.

In step 612, a first level classification of the input is determined in the first level of the first taxonomy based on the second classification. For instance, a first level classification of the input in the first level of the first taxonomy is determined based on the first classification and the second classification. For example, results processor 306 may output ML-generated classification 142 as level classification 310 of input 140 in the first level of the taxonomy if the first confidence score is greater than the second confidence score, or output LLM-generated classification 148 as level classification 310 of input 140 in the first level of the taxonomy if the second confidence score is greater than the first confidence score.

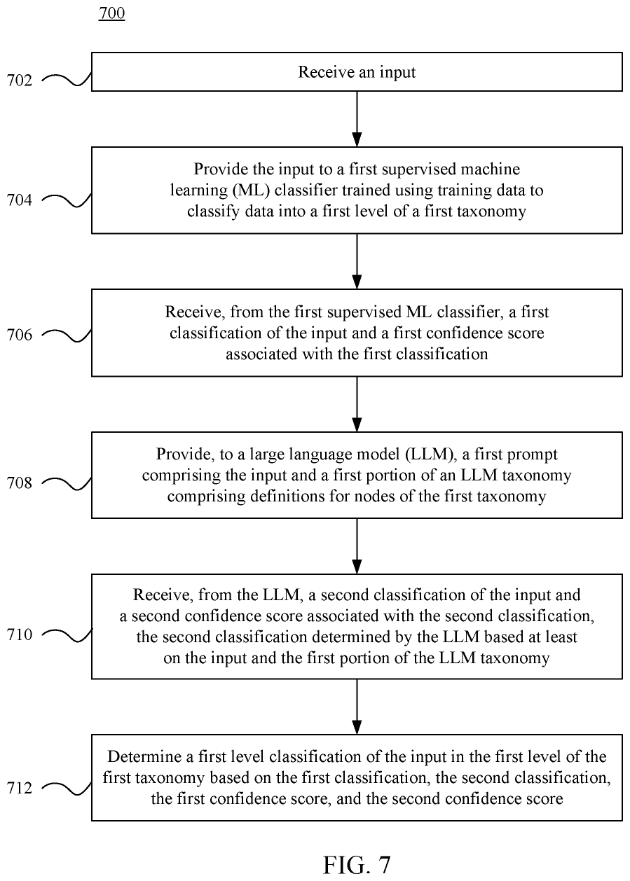

Embodiments described herein may operate in various ways to classify an input into a first layer of a taxonomy using a hybrid AI classifier. For example, FIG. 7 depicts a flowchart 700 of a process for classifying an input into a first layer of a taxonomy using a hybrid AI classifier, in accordance with an embodiment. Server infrastructure 106, LLM taxonomy storage 116, supervised ML model(s) 120, LLM 122, AI classifier 124, taxonomic level classifier 302, prompt generator 304, results processor 306 of FIGS. 1 and 3 may operate in accordance with flowchart 700. Note that not all steps of flowchart 700 may need to be performed in all embodiments, and in some embodiments, the steps of flowchart 700 may be performed in different orders than shown. Flowchart 700 is described as follows with respect to FIGS. 1 and 3 for illustrative purposes.

Flowchart 700 starts at step 702. In step 702, an input is received. For example, taxonomic level classifier 302 may receive input 140 from client(s) 104 as part of classification request 138.

In step 704, the input is provided to a first supervised ML classifier trained using training data to classify data into a first level of a first taxonomy. For example, For example, taxonomic level classifier 302 may provide input 140 to a first supervised ML model 120 trained to classify data into a first level of the taxonomy.

In step 706, a first classification of the input and a first confidence score associated with the first classification are received from the first supervised ML classifier. For example, results processor 306 may receive, from supervised ML model(s) 120, ML-generated classification 142 that may include a first classification and/or a confidence score associated with the first classification.

In step 708, a first prompt is provided to an LLM, the first prompt comprising the input, and a first portion of the LLM taxonomy comprising definitions of nodes of the first taxonomy. For example, prompt generator 304 may provide, to LLM 122, prompt 146 that may include a high-level instruction for LLM 122 requesting classification of input 140 into the portion of LLM taxonomy 144, input 140, and/or the portion of LLM taxonomy 144.

In step 710, a second classification of the input and a second confidence score associated with the second classification are received from the LLM, the second classification determined by the LLM based at least on the input and the first portion of the LLM taxonomy. For example, results processor 306 may receive, from LLM 122, LLM-generated classification 148 generated by LLM 122 based on input 140 and the portion of LLM taxonomy 144 and/or a second confidence score associated with LLM-generated classification 148.

In step 712, a first level classification of the input in the first level of the first taxonomy is determined based on the first classification, the second classification, the first confidence score, and the second confidence score. For example, results processor 306 may output ML-generated classification 142 as level classification 310 of input 140 in the first level of the taxonomy if a first confidence score associated with ML-generated classification 142 is greater than a second confidence score associated with LLM-generated classification 148, or output LLM-generated classification 148 as level classification 310 of input 140 in the first level of the taxonomy if the second confidence score associated with LLM-generated classification 148 is greater than the first confidence score associated with ML-generated classification 142.

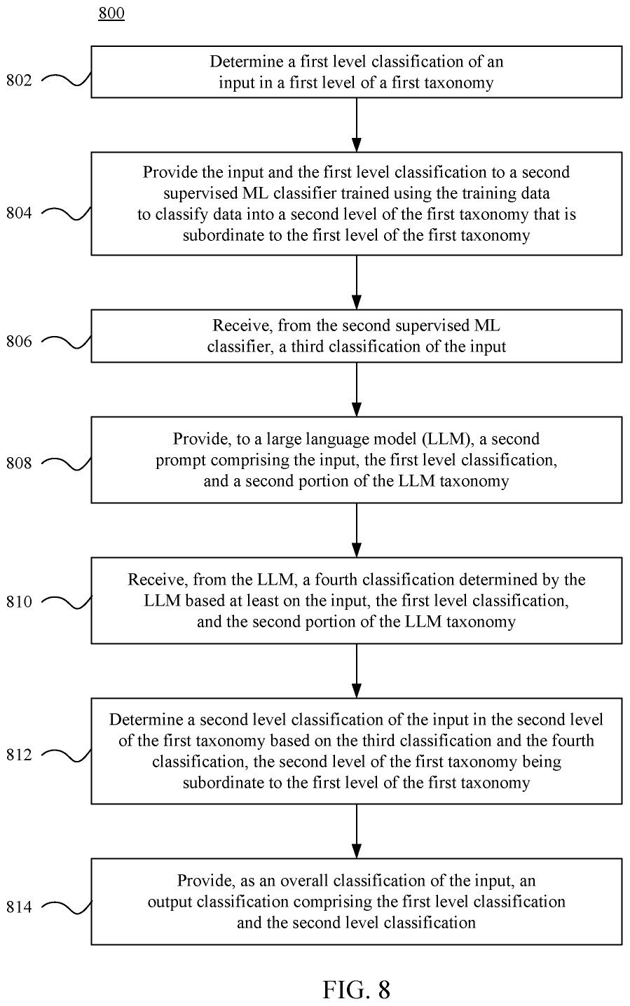

Embodiments described herein may operate in various ways to classify an input into multiple layers of a taxonomy using a hybrid AI classifier. FIG. 8 depicts a flowchart 800 of a process for classifying an input into multiple layers of a taxonomy using a hybrid AI classifier, in accordance with an embodiment. Server infrastructure 106, LLM taxonomy storage 116, supervised ML model(s) 120, LLM 122, AI classifier 124, taxonomic level classifier 302, prompt generator 304, results processor 306 of FIGS. 1 and 3 may operate in accordance with flowchart 800. Note that not all steps of flowchart 800 may need to be performed in all embodiments, and in some embodiments, the steps of flowchart 800 may be performed in different orders than shown. Flowchart 800 is described as follows with respect to FIGS. 1 and 3 for illustrative purposes.

Flowchart 800 starts at step 802. In step 802, a first level classification of an input in a first level of a first taxonomy is determined. For example, results processor 306 may determine level classification 310 of input 140 in a first level of the taxonomy based on ML-generated classification 142 and LLM-generated classification 148.

In step 804, the input and the first level classification are provided to a second supervised ML classifier trained using the training data to classify data into a second level of the first taxonomy that is subordinate to the first level of the first taxonomy. For example, taxonomic level classifier 302 may provide input 140 to a second supervised ML model 120 trained to classify data into the second level of the taxonomy.

In step 806, a third classification of the input is received from the second supervised ML classifier. For example, results processor 306 may receive, from supervised ML model(s) 120, ML-generated classification 142 that may include third classification of input 140.

In step 808, a second prompt comprising the input, the first level classification, and a second portion of the LLM taxonomy is provided to an LLM. For example, prompt generator 304 may provide prompt 146 to LLM 122, prompt 146 comprising at least input 140, the portion of LLM taxonomy 144, and/or level classification 310 of input 140 in the first level of the taxonomy.

In step 810, a fourth classification is received from the LLM, the fourth classification determined by the LLM based at least on the input, the first level classification, and the second portion of the LLM taxonomy. For example, results processor 306 may receive, from LLM 122, LLM-generated classification 148 generated by LLM 122 based at least on input 140, the portion of LLM taxonomy 144, and/or level classification 310 of input 140 in the first level of the taxonomy.

In step 812, a second level classification of the input in the second level of first taxonomy is determined based on the third classification and the fourth classification, the second level of the first taxonomy being subordinate to the first level of the first taxonomy. For example, results processor 306 may determine level classification 310 of input 140 in a second level of the taxonomy based on ML-generated classification 142 and LLM-generated classification 148.

In step 814, an output classification is provided as an overall classification of the input, the output classification comprising the first level classification and the second level classification. For example, taxonomic level classifier 302 provides an overall classification to client(s) 104 in response(s) 150, the overall classification comprising level classification 310 of input 140 in the first level of the taxonomy and level classification 310 of input 140 in the second level of the taxonomy.

### III. Example Mobile Device and Computer System Implementation

The systems and methods described above in reference to FIGS. 1-8, including client(s) 102, client(s) 104, server infrastructure 106, network(s) 108, interface 110, application 112, taxonomy manager 114, LLM taxonomy storage 116, supervised ML model storage 118, supervised ML model(s) 120, LLM 122, AI classifier 124, interface manager 202, taxonomy generator 204, LLM taxonomy generator 206, supervised ML taxonomy extractor 208, supervised ML model trainer 210, taxonomic level classifier 302, prompt generator 304, results processor 306, and/or each of the components described therein, and/or the steps of flowcharts 400, 500, 600, 700, and/or 800 may be implemented in hardware, or hardware combined with one or both of software and/or firmware. For example, client(s) 102, client(s) 104, server infrastructure 106, network(s) 108, interface 110, application 112, taxonomy manager 114, LLM taxonomy storage 116, supervised ML model storage 118, supervised ML model(s) 120, LLM 122, AI classifier 124, interface manager 202, taxonomy generator 204, LLM taxonomy generator 206, supervised ML taxonomy extractor 208, supervised ML model trainer 210, taxonomic level classifier 302, prompt generator 304, results processor 306, and/or each of the components described therein, and/or the steps of flowcharts 400, 500, 600, 700, and/or 800 may be each implemented as computer program code/instructions configured to be executed in one or more processors and stored in a computer readable storage medium. Alternatively, client(s) 102, client(s) 104, server infrastructure 106, network(s) 108, interface 110, application 112, taxonomy manager 114, LLM taxonomy storage 116, supervised ML model storage 118, supervised ML model(s) 120, LLM 122, AI classifier 124, interface manager 202, taxonomy generator 204, LLM taxonomy generator 206, supervised ML taxonomy extractor 208, supervised ML model trainer 210, taxonomic level classifier 302, prompt generator 304, results processor 306, and/or each of the components described therein, and/or the steps of flowcharts 400, 500, 600, 700, and/or 800 may be each implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 9. FIG. 9 shows a block diagram of an exemplary computing environment 900 that includes a computing device 902. Computing device 902 is an example of client(s) 102 and/or client(s) 104 shown in FIG. 1, which may each include one or more of the components of computing device 902. In some embodiments, computing device 902 is communicatively coupled with devices (not shown in FIG. 9) external to computing environment 900 via network 904. Network 904 comprises one or more networks such as local area networks (LANs), wide area networks (WANs), enterprise networks, the Internet, etc., and may include one or more wired and/or wireless portions. Network 904 may additionally or alternatively include a cellular network for cellular communications. Computing device 902 is described in detail as follows.

Computing device 902 can be any of a variety of types of computing devices. For example, computing device 902 may be a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. Computing device 902 may alternatively be a stationary computing device such as a desktop computer, a personal computer (PC), a stationary server device, a minicomputer, a mainframe, a supercomputer, etc.

As shown in FIG. 9, computing device 902 includes a variety of hardware and software components, including a processor 910, a storage 920, one or more input devices 950, one or more output devices 950, one or more wireless modems f0, one or more wired interfaces 960, a power supply 962, a location information (LI) receiver 964, and an accelerometer 966. Storage 920 includes memory 956, which includes non-removable memory 922 and removable memory 924, and a storage device 990. Storage 920 also stores an operating system 912, application programs 914, and application data 916. Wireless modem(s) 960 include a Wi-Fi modem 962, a Bluetooth modem 964, and a cellular modem 966. Output device(s) 950 includes a speaker 952 and a display 954. Input device(s) 950 includes a touch screen 952, a microphone 954, a camera 956, a physical keyboard 958, and a trackball 940. Not all components of computing device 902 shown in FIG. 9 are present in all embodiments, additional components not shown may be present, and any combination of the components may be present in a particular embodiment. These components of computing device 902 are described as follows.

A single processor 910 (e.g., central processing unit (CPU), microcontroller, a microprocessor, signal processor, ASIC (application specific integrated circuit), and/or other physical hardware processor circuit) or multiple processors 910 may be present in computing device 902 for performing such tasks as program execution, signal coding, data processing, input/output processing, power control, and/or other functions. Processor 910 may be a single-core or multi-core processor, and each processor core may be single-threaded or multithreaded (to provide multiple threads of execution concurrently). Processor 910 is configured to execute program code stored in a computer readable medium, such as program code of operating system 912 and application programs 914 stored in storage 920. The program code is structured to cause processor 910 to perform operations, including the processes/methods disclosed herein. Operating system 912 controls the allocation and usage of the components of computing device 902 and provides support for one or more application programs 914 (also referred to as “applications” or “apps”). Application programs 914 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. Processor(s) 910 may include one or more general processors (e.g., CPUs) configured with or coupled to one or more hardware accelerators, such as one or more NPUs and/or one or more GPUs.

Any component in computing device 902 can communicate with any other component according to function, although not all connections are shown for ease of illustration. For instance, as shown in FIG. 9, bus 906 is a multiple signal line communication medium (e.g., conductive traces in silicon, metal traces along a motherboard, wires, etc.) that may be present to communicatively couple processor 910 to various other components of computing device 902, although in other embodiments, an alternative bus, further buses, and/or one or more individual signal lines may be present to communicatively couple components. Bus 906 represents one or more of any of several types of bus structures, including a memory bus or memory controller, a peripheral bus, an accelerated graphics port, and a processor or local bus using any of a variety of bus architectures.

Storage 920 is physical storage that includes one or both of memory 956 and storage device 990, which store operating system 912, application programs 914, and application data 916 according to any distribution. Non-removable memory 922 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 922 may include main memory and may be separate from or fabricated in a same integrated circuit as processor 910. As shown in FIG. 9, non-removable memory 922 stores firmware 918, which may be present to provide low-level control of hardware. Examples of firmware 918 include BIOS (Basic Input/Output System, such as on personal computers) and boot firmware (e.g., on smart phones). Removable memory 924 may be inserted into a receptacle of or otherwise coupled to computing device 902 and can be removed by a user from computing device 902. Removable memory 924 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 990 may be present that are internal and/or external to a housing of computing device 902 and may or may not be removable. Examples of storage device 990 include a hard disk drive, a SSD, a thumb drive (e.g., a USB (Universal Serial Bus) flash drive), or other physical storage device.

One or more programs may be stored in storage 920. Such programs include operating system 912, one or more application programs 914, and other program modules and program data. Examples of such application programs may include, for example, computer program logic (e.g., computer program code/instructions) for implementing client(s) 102, client(s) 104, server infrastructure 106, network(s) 108, interface 110, application 112, taxonomy manager 114, LLM taxonomy storage 116, supervised ML model storage 118, supervised ML model(s) 120, LLM 122, AI classifier 124, interface manager 202, taxonomy generator 204, LLM taxonomy generator 206, supervised ML taxonomy extractor 208, supervised ML model trainer 210, taxonomic level classifier 302, prompt generator 304, results processor 306, and/or each of the components described therein, as well as any of flowcharts 400, 500, 600, 700, and/or 800, and/or any individual steps thereof.

Storage 920 also stores data used and/or generated by operating system 912 and application programs 914 as application data 916. Examples of application data 916 include web pages, text, images, tables, sound files, video data, and other data, which may also be sent to and/or received from one or more network servers or other devices via one or more wired or wireless networks. Storage 920 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 902 through one or more input devices 950 and may receive information from computing device 902 through one or more output devices 950. Input device(s) 950 may include one or more of touch screen 952, microphone 954, camera 956, physical keyboard 958 and/or trackball 940 and output device(s) 950 may include one or more of speaker 952 and display 954. Each of input device(s) 950 and output device(s) 950 may be integral to computing device 902 (e.g., built into a housing of computing device 902) or external to computing device 902 (e.g., communicatively coupled wired or wirelessly to computing device 902 via wired interface(s) 960 and/or wireless modem(s) 960). Further input devices 950 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 954 may display information, as well as operating as touch screen 952 by receiving user commands and/or other information (e.g., by touch, finger gestures, virtual keyboard, etc.) as a user interface. Any number of each type of input device(s) 950 and output device(s) 950 may be present, including multiple microphones 954, multiple cameras 956, multiple speakers 952, and/or multiple displays 954.

One or more wireless modems 960 can be coupled to antenna(s) (not shown) of computing device 902 and can support two-way communications between processor 910 and devices external to computing device 902 through network 904, as would be understood to persons skilled in the relevant art(s). Wireless modem 960 is shown generically and can include a cellular modem 966 for communicating with one or more cellular networks, such as a GSM network for data and voice communications within a single cellular network, between cellular networks, or between the mobile device and a public switched telephone network (PSTN). Wireless modem 960 may also or alternatively include other radio-based modem types, such as a Bluetooth modem 964 (also referred to as a “Bluetooth device”) and/or Wi-Fi modem 962 (also referred to as an “wireless adaptor”). Wi-Fi modem 962 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 964 is configured to communicate with another Bluetooth-capable device according to the Bluetooth short-range wireless technology standard(s) such as IEEE 802.15.1 and/or managed by the Bluetooth Special Interest Group (SIG).

Computing device 902 can further include power supply 962, LI receiver 964, accelerometer 966, and/or one or more wired interfaces 960. Example wired interfaces 960 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 960 of computing device 902 provide for wired connections between computing device 902 and network 904, or between computing device 902 and one or more devices/peripherals when such devices/peripherals are external to computing device 902 (e.g., a pointing device, display 954, speaker 952, camera 956, physical keyboard 958, etc.). Power supply 962 is configured to supply power to each of the components of computing device 902 and may receive power from a battery internal to computing device 902, and/or from a power cord plugged into a power port of computing device 902 (e.g., a USB port, an A/C power port). LI receiver 964 may be used for location determination of computing device 902 and may include a satellite navigation receiver such as a Global Positioning System (GPS) receiver or may include other type of location determiner configured to determine location of computing device 902 based on received information (e.g., using cell tower triangulation, etc.). Accelerometer 966 may be present to determine an orientation of computing device 902.

Note that the illustrated components of computing device 902 are not required or all-inclusive, and fewer or greater numbers of components may be present as would be recognized by one skilled in the art. For example, computing device 902 may also include one or more of a gyroscope, barometer, proximity sensor, ambient light sensor, digital compass, etc. Processor 910 and memory 956 may be co-located in a same semiconductor device package, such as being included together in an integrated circuit chip, FPGA, or system-on-chip (SOC), optionally along with further components of computing device 902.

In embodiments, computing device 902 is configured to implement any of the above-described features of flowcharts herein. Computer program logic for performing any of the operations, steps, and/or functions described herein may be stored in storage 920 and executed by processor 910.

In some embodiments, server infrastructure 970 may be present in computing environment 900 and may be communicatively coupled with computing device 902 via network 904. Server infrastructure 970, when present, may be a network-accessible server set (e.g., a cloud-based environment or platform). As shown in FIG. 9, server infrastructure 970 includes clusters 972. Each of clusters 972 may comprise a group of one or more compute nodes and/or a group of one or more storage nodes. For example, as shown in FIG. 9, cluster 972 includes nodes 974. Each of nodes 974 are accessible via network 904 (e.g., in a “cloud-based” embodiment) to build, deploy, and manage applications and services. Any of nodes 974 may be a storage node that comprises a plurality of physical storage disks, SSDs, and/or other physical storage devices that are accessible via network 904 and are configured to store data associated with the applications and services managed by nodes 974. For example, as shown in FIG. 9, nodes 974 may store application data 978.

Each of nodes 974 may, as a compute node, comprise one or more server computers, server systems, and/or computing devices. For instance, a node 974 may include one or more of the components of computing device 902 disclosed herein. Each of nodes 974 may be configured to execute one or more software applications (or “applications”) and/or services and/or manage hardware resources (e.g., processors, memory, etc.), which may be utilized by users (e.g., customers) of the network-accessible server set. For example, as shown in FIG. 9, nodes 974 may operate application programs 976. In an implementation, a node of nodes 974 may operate or comprise one or more virtual machines, with each virtual machine emulating a system architecture (e.g., an operating system), in an isolated manner, upon which applications such as application programs 976 may be executed.

In an embodiment, one or more of clusters 972 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 972 may be a datacenter in a distributed collection of datacenters. In embodiments, exemplary computing environment 900 comprises part of a cloud-based platform.

In an embodiment, computing device 902 may access application programs 976 for execution in any manner, such as by a client application and/or a browser at computing device 902.

For purposes of network (e.g., cloud) backup and data security, computing device 902 may additionally and/or alternatively synchronize copies of application programs 914 and/or application data 916 to be stored at network-based server infrastructure 970 as application programs 976 and/or application data 978. For instance, operating system 912 and/or application programs 914 may include a file hosting service client configured to synchronize applications and/or data stored in storage 920 at network-based server infrastructure 970.

In some embodiments, on-premises servers 992 may be present in computing environment 900 and may be communicatively coupled with computing device 902 via network 904. On-premises servers 992, when present, are hosted within an organization's infrastructure and, in many cases, physically onsite of a facility of that organization. On-premises servers 992 are controlled, administered, and maintained by IT (Information Technology) personnel of the organization or an IT partner to the organization. Application data 998 may be shared by on-premises servers 992 between computing devices of the organization, including computing device 902 (when part of an organization) through a local network of the organization, and/or through further networks accessible to the organization (including the Internet). Furthermore, on-premises servers 992 may serve applications such as application programs 996 to the computing devices of the organization, including computing device 902. Accordingly, on-premises servers 992 may include storage 994 (which includes one or more physical storage devices such as storage disks and/or SSDs) for storage of application programs 996 and application data 998 and may include one or more processors for execution of application programs 996. Still further, computing device 902 may be configured to synchronize copies of application programs 914 and/or application data 916 for backup storage at on-premises servers 992 as application programs 996 and/or application data 998.

Embodiments described herein may be implemented in one or more of computing device 902, network-based server infrastructure 970, and on-premises servers 992. For example, in some embodiments, computing device 902 may be used to implement systems, clients, or devices, or components/subcomponents thereof, disclosed elsewhere herein. In other embodiments, a combination of computing device 902, network-based server infrastructure 970, and/or on-premises servers 992 may be used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 920. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 914) may be stored in storage 920. Such computer programs may also be received via wired interface(s) 960 and/or wireless modem(s) 960 over network 904. Such computer programs, when executed or loaded by an application, enable computing device 902 to implement features of embodiments discussed herein. Accordingly, such computer programs represent controllers of the computing device 902.

Embodiments are also directed to computer program products comprising computer code or instructions stored on any computer-readable medium or computer-readable storage medium. Such computer program products include the physical storage of storage 920 as well as further physical storage types.

### IV. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for generating an artificial intelligence (AI) classifier, the method comprising:
determining a first taxonomy comprising a set of nodes;
receiving training data for a first subset of the set of nodes;
determining a supervised machine learning (ML) taxonomy comprising the first subset;
training a first supervised ML classifier based on the training data, the first supervised ML classifier trained to classify data into a first level of the supervised ML taxonomy;
determining a large language model (LLM) taxonomy comprising definitions for a second subset of the set of nodes; and
deploying a hybrid classifier enabled to classify an input based on a first classification determined, by the first supervised ML classifier, based on the input, and a second classification generated, by the LLM, based on a prompt comprising the input and at least a portion of the LLM taxonomy.

2. The method of claim 1, wherein the hybrid classifier classifies the input by:
providing the input to the first supervised ML classifier;
receiving, from the first supervised ML classifier, the first classification;
providing, to the LLM, the prompt comprising the input, a first portion of the LLM taxonomy, and the first classification;
receiving, from the LLM, the second classification; and
determining a first level classification of the input in the first level of the first taxonomy based on the second classification.

3. The method of claim 1, wherein the hybrid classifier classifies the input by:
providing the input to the first supervised ML classifier;
receiving, from the first supervised ML classifier, the first classification and a first confidence score associated with the first classification;
providing, to the LLM, the prompt comprising the input and a first portion of the LLM taxonomy;
receiving, from the LLM, the second classification and a second confidence score associated with the second classification; and
determining a first level classification of the input in the first level of the first taxonomy based on the first output, the second output, the first confidence score, and the second confidence score.

4. The method of claim 1, further comprising:
training a second supervised ML classifier based on the training data, the second supervised ML classifier trained to classify data into a second level of the supervised ML taxonomy;
providing, to the second supervised ML classifier, the input and the first level classification;
receiving, from the second supervised ML classifier, a third classification of the input;
providing, to a large language model (LLM), a second prompt comprising the input, the first level classification, and a second portion of the LLM taxonomy;
receiving, from the LLM, a fourth classification determined by the LLM based at least on the input, the first level classification, and the second portion of the LLM taxonomy;
determining a second level classification of the input in the second level of the first taxonomy based on the third classification and the fourth classification, the second level of the first taxonomy being subordinate to the first level of the first taxonomy; and
providing, as an overall classification of the input, an output classification comprising the first level classification and the second level classification.

5. The method of claim 1, wherein determining the LLM taxonomy comprises at least one of:
receiving, from a user via a user interface, a definition for a node of the second subset;
determining a definition for a node of the second subset based on an analysis of the training data associated with the first subset; or
determining a definition for a node of the second subset based on information associated with ancestor nodes of the node of the second subset.

6. The method of claim 1, wherein the training data comprises at least one of:
user-provided training data associated with a node of the first taxonomy; or
training data retrieved based on a user-provided document identifier and associated with a node of the first taxonomy, the user-provided document identifier comprising at least one of: a publication identifier, or a patent number.

7. The method of claim 1, wherein the first taxonomy is a hierarchical taxonomy, and determining the first taxonomy comprises at least one of:
receiving, from a user via a user interface, at least a portion of the first taxonomy;
automatically generating at least a portion of the first taxonomy based on user input; or
generating the first taxonomy based on user modifications to a previously generated taxonomy.

8. A system for classifying an input into a node of a taxonomy, the system comprising:
a processor; and
a memory device that stores program code structured to cause the processor to:
receive the input;
provide the input to a first supervised machine learning (ML) classifier trained using training data to classify data into a first level of the first taxonomy;
receive, from the first supervised ML classifier, a first classification of the input;
provide, to a large language model (LLM), a first prompt comprising the input and a first portion of an LLM taxonomy comprising definitions for nodes of the first taxonomy;
receive, from the LLM, a second classification of the input determined by the LLM based at least on the input and the first portion of the LLM taxonomy; and
determine a first level classification of the input in the first level of the first taxonomy based on the first classification and the second classification.

9. The system of claim 8, wherein, to determine a first level classification of the input in the first level of the first taxonomy based on the first classification and the second classification, the program code is structured to further cause the processor to:
provide the first classification in the prompt to the LLM, the LLM determining the second classification further based on the first classification; and
determine the second classification as the first level classification of the input in the first level of the first taxonomy.

10. The system of claim 8, wherein, to determine a first level classification of the input in the first level of the first taxonomy based on the first classification and the second classification, the program code is structured to further cause the processor to:
receive, from the first supervised ML classifier, a first confidence score associated with the first classification;
receive, from the LLM, a second confidence score associated with the second classification; and
determine the first level classification of the input in the first level of the first taxonomy based on the first classification, the second classification, the first confidence score, and the second confidence score.

11. The system of claim 8, wherein the program code is structured to further cause the processor to:
provide the input and the first level classification to a second supervised ML classifier trained using the training data to classify data into a second level of the first taxonomy that is subordinate to the first level;
receive, from the second supervised ML classifier, a third classification for the input;
provide, to a large language model (LLM), a second prompt comprising the input, the first level classification, and a second portion of the LLM taxonomy;
receive, from the LLM, a fourth classification, the fourth classification determined by the LLM based at least on the input, the first level classification, and the second portion of the LLM taxonomy;
determine a second level classification of the input in a second level of the first taxonomy based on the third classification and the fourth classification, the second level of the first taxonomy being subordinate to the first level of the first taxonomy; and
provide, as an overall classification of the input, an output classification comprising the first level classification and the second level classification.

12. The system of claim 8, wherein the LLM taxonomy comprises at least one of:
a definition for a node of the first taxonomy received from a user via a user interface;
a definition for a node of the first taxonomy determined based on an analysis of training data;
a definition for a node of the first taxonomy determined based on information associated with subordinate nodes of the node; or
a definition for a node of the first taxonomy determined based on information associated with ancestor nodes of the node.

13. The system of claim 8, wherein the training data comprises at least one of:
user-provided training data associated with a node of the first taxonomy; or
training data retrieved based on a user-provided document identifier and associated with a node of the first taxonomy, the user-provided document identifier comprising at least one of: a publication identifier, or a patent number.

14. The system of claim 8, wherein the first taxonomy comprises at least one of:
a hierarchical taxonomy received from a user via a user interface;
a hierarchical taxonomy automatically generate based on user input; or
a hierarchical taxonomy generated based on user modifications to a previously generated taxonomy.

15. A computer-readable storage medium comprising computer-executable instructions that, when executed by a processor, cause the processor to:
receive an input;
provide the input to a first supervised machine learning (ML) classifier trained using training data to classify data into a first level of the first taxonomy;
receive, from the first supervised ML classifier, a first classification for the input;
provide, to a large language model (LLM), a first prompt comprising the input and a first portion of an LLM taxonomy comprising definitions for nodes of the first taxonomy;
receive, from the LLM, a second classification determined by the LLM based at least on the input and the first portion of the LLM taxonomy; and
determine a first level classification of the input in the first level of the first taxonomy based on the first classification and the second classification.

16. The computer-readable storage medium of claim 15, wherein, to determine a first level classification of the input in the first level of the first taxonomy based on the first classification and the second classification, the computer-executable instructions, when executed by the processor, further cause the processor to:
provide, to the LLM, the first classification in the prompt, the second classification determined by the LLM further based on the first classification; and
determine the second classification as the first level classification of the first level of the first taxonomy.

17. The computer-readable storage medium of claim 15, wherein, to determine a first level classification for the first level of the first taxonomy based on the first classification and the second classification, the computer-executable instructions, when executed by the processor, further cause the processor to:
receive, from the supervised first ML classifier, a first confidence score associated with the first classification;
receive, from the LLM, a second confidence score associated with the second classification; and
determine the first level classification of the input in the first level of the first taxonomy based on the first classification, the second classification, the first confidence score, and the second confidence score.

18. The computer-readable storage medium of claim 15, wherein the computer-executable instructions, when executed by the processor, further cause the processor to:
provide the input and the first level classification to a second supervised ML classifier trained using the training data to classify data into a second level of the first taxonomy that is subordinate to the first level;
receive, from the second supervised ML classifier, a third classification for the input;
provide, to a large language model (LLM), a second prompt comprising the input, the first level classification, and a second portion of the LLM taxonomy;
receive, from the LLM, a fourth classification, the fourth classification determined by the LLM based at least on the input, the first level classification, and the second portion of the LLM taxonomy;
determine a second level classification of the input in a second level of the first taxonomy based on the third classification and the fourth classification, the second level of the first taxonomy being subordinate to the first level of the first taxonomy; and
provide, as an overall classification of the input, an output classification comprising the first level classification and the second level classification.

19. The computer-readable storage medium of claim 15, wherein the LLM taxonomy comprises at least one of:
a definition for a node of the first taxonomy received from a user via a user interface;
a definition for a node of the first taxonomy determined based on an analysis of training data;
a definition for a node of the first taxonomy determined based on information associated with subordinate nodes of the node; or
a definition for a node of the first taxonomy determined based on information associated with ancestor nodes of the node.

20. The computer-readable storage medium of claim 15, wherein the training data comprises at least one of:
user-provided training data associated with a node of the first taxonomy; or
training data retrieved based on a user-provided document identifier and associated with a node of the first taxonomy, the user-provided document identifier comprising at least one of: a publication identifier, or a patent number.
